(19) United States
(12) Patent Application Publication
(10) Pub. No.: US 2016/0264247 A1
(43) Pub. Date: Sep. 15, 2016

(54) CONTROL UNIT DEVICE FOR AN AIRCRAFT SEAT

(71) Applicant: RECARO AIRCRAFT SEATING GMBH & CO.KG, Schwäbisch Hall (DE)

(72) Inventors: Adrian PHILIPP, Michelbach a. d. Bilz (DE); Michael GERNGROSS, Michelfeld (DE); Michael STRECKERT, Schwaebisch Hall (DE); Juergen MEHMEL, Schwaebisch Hall (DE); Joerg LAUBENBERGER, Murrhardt (DE)

(21) Appl. No.: 15/036,074

(22) PCT Filed: Nov. 7, 2014
(86) PCT No.: PCT/EP2014/074074

§ 371 Date: May 12, 2016

(30) Foreign Application Priority Data
Nov. 13, 2013 (DE) 10 2013 112 491.7

(51) Int. Cl. B64D 11/06

(52) U.S. Cl. CPC B64D 11/0639; B64D 11/06395

(57) ABSTRACT

The invention concerns a control unit device for an aircraft seat, with a control and/or regulating unit, with at least one actuator unit coupled to the control and/or regulating unit, and with at least one additional unit. According to the invention, the additional unit is coupled via the actuator unit to the control and/or regulating unit.

### PRIOR ART

The invention relates to a control unit device as claimed in the preamble of patent claim 1.

A control unit device for an aircraft seat, having a control and/or regulation unit, having at least one actuator unit which is coupled to the control and/or regulation unit, and having at least one additional unit, has already been proposed.

The object of the invention is, in particular, to provide a device of this generic type which has improved properties in respect of simplicity and a number of components. According to the invention, the object is achieved by the features of patent claim 1, it being possible to gather advantageous refinements and developments of the invention from the dependent claims.

### ADVANTAGES OF THE INVENTION

The invention is based on a control unit device for an aircraft seat, having a control and/or regulation unit, having at least one actuator unit which is coupled to the control and/or regulation unit, and having at least one additional unit.

It is proposed that the additional unit is coupled to the control and/or regulation unit via the actuator unit. A “control and/or regulation unit” is intended to be understood to mean, in particular, a unit having at least one controller. A “controller” is intended to be understood to mean, in particular, a unit having a processor unit and having a memory unit and also having an operating program which is stored in the memory unit. In principle, the control and/or regulation unit can have a plurality of controllers which are connected to one another and which are preferably intended for the purpose of communicating with one another via a bus system, such as a CAN bus system in particular. In this case, an “aircraft seat” is intended to be understood to mean, in particular, a seat which is arranged in an aircraft cabin and in this case is preferably mounted on a cabin floor of the aircraft cabin. In this case, an “actuator unit” is intended to be understood to mean, in particular, a unit comprising at least one actuator. An “actuator” is intended to be understood to mean, in particular, a mechatronic component which is provided for the purpose of converting electrical signals into a movement, for example into a pivoting and/or linear movement. In this case, an actuator comprises at least one integrated control unit which controls the actuator and also processes input signals and/or passes on output signals to the actuator or other electronic components. In this case, an “additional unit” is intended to be understood to mean, in particular, an electronic unit which is provided for the purpose of transmitting and/or receiving electrical and/or electronic signals. In this case, “coupled” is intended to be understood to mean, in particular, electrically and/or electronically connected to one another, so that the coupled elements, such as the control and/or regulation unit and the additional unit in particular, communicate with one another, that is to say can exchange electrical and/or electronic signals with one another. In this case, “coupled via the actuator unit” is intended to be understood to mean, in particular, that communication takes place between two elements, which are coupled to one another via the actuator unit, via the actuator unit, that is to say electrical and/or electronic signals which serve for communication purposes are carried at least partially by means of an electronics system of the actuator unit. “Provided” is intended to be understood to mean, in particular, specially programmed, designed and/or equipped. When it is stated that an object is intended for a specific function, this is intended to be understood to mean, in particular, that the object fulfills and/or executes this specific function in at least one use and/or operating state. By virtue of a refinement according to the invention, an additional unit can advantageously be connected particularly advantageously to a control and/or regulation unit, as a result of which, in particular, a particularly simple control unit device which is advantageous in respect of a number of components is provided.

It is also proposed that the actuator unit comprises at least one plug element, via which the actuator unit is coupled to the control and/or regulation unit, wherein the additional unit is connected to the actuator unit via the plug element. In this case, a “plug element” is intended to be understood to mean, in particular, an element which provides the electrical contact in order to electrically and/or electronically couple an electrical and/or electronic component, such as an actuator unit or a control and/or regulation unit in particular, to other electrical and/or electronic components by means of a cable and/or a further plug element. As a result, the at least one additional unit can be connected to the control and/or regulation unit via the at least one actuator unit in a particularly simple manner.

It is furthermore proposed that the plug element has at least one pin, via which the actuator unit is connected to the control and/or regulation unit, and has at least one further pin, via which the additional unit is connected to the actuator unit. In this case, a “pin” is intended to be understood to mean, in particular, an electrical contact point which is directly connected to an electrical contact point of a corresponding plug element in order to thereby conduct an electric current from one plug element to the other plug element. As a result, both the control and/or regulation unit and also the additional unit can be connected to the actuator unit in a particularly simple and advantageous manner.

Furthermore, it is proposed that the actuator unit has an integrated control unit which has at least one input, via which the pin for the additional unit is connected. In this case, an “integrated control unit” is intended to be understood to mean, in particular, a microprocessor which is integrated into the actuator unit, which at least drives actuators of the actuator unit, processes input signals and outputs output signals. As a result, the additional unit can be connected to the actuator unit in a particularly advantageous manner.

In addition, it is proposed that the additional unit is embodied as a sensor element. In this case, a “sensor element” is intended to be understood to mean, in particular, an element which outputs a corresponding electrical and/or electronic signal on the basis of a switching position and/or a detected physical variable. In this case, the sensor element can be embodied as, for example, a location sensor, a switch, a position sensor or a distance sensor. As a result, a sensor element, via which control signals are intended to be passed on to the control and/or regulation unit for processing purposes can be connected to the control and/or regulation unit in a particularly simple and advantageous manner.

It is further proposed that the additional unit is embodied as an actuator element. In this case, an “actuator element” is intended to be understood to mean, in particular, an element which reacts to a defined input signal with a defined action. In this case, an actuator element can be implemented as a light element, such as an LED for example, embodied as a switching valve or as a locking device, e.g. as a magnetic pin locking arrangement, for a mechanical system/kinematics system. In this case, an actuator element is designed, in particular, without an integrated control unit and reacts simply to an input signal. As a result, an actuator element which is driven by the control and/or regulation unit can be connected to the control and/or regulation unit in a particularly simple and advantageous manner.

It is also proposed that the plug element is embodied as an aviation-approved plug element. In this case, an “aviation-approved plug element” is intended to be understood to mean, in particular, a plug element which is approved for use in an aircraft by an aviation authority. As a result, the plug element can be particularly advantageously designed for use in an aircraft seat.

It is furthermore proposed that the plug element is embodied as a D-sub 9-pin plug. As a result, the plug element can be designed in a particularly advantageous manner.

In addition, a method for connecting an actuator unit and an additional unit to a control and/or regulation unit is proposed, wherein the additional unit is connected to the control and/or regulation unit via the actuator unit.

In this case, the control unit device according to the invention is not intended to be restricted to the use and embodiment described above. In particular, it is possible for the control unit device according to the invention to have a number of individual elements, components and units which differs from the number cited herein for the purpose of performing a function described herein.

### DRAWINGS

Further advantages can be gathered from the following description of the drawings. The drawings illustrate an exemplary embodiment of the invention. The drawing, the description and the claims contain numerous features in combination. A person skilled in the art will expediently also look at the features individually and combine them to form further appropriate combinations.

In the drawings:

FIG. 1 is a schematic illustration of an aircraft seat with a schematic illustration of a control unit device according to the invention, and

FIG. 2 is a schematic illustration of a circuit diagram of the control unit device according to the invention.

### DESCRIPTION OF THE EXEMPLARY EMBODIMENT

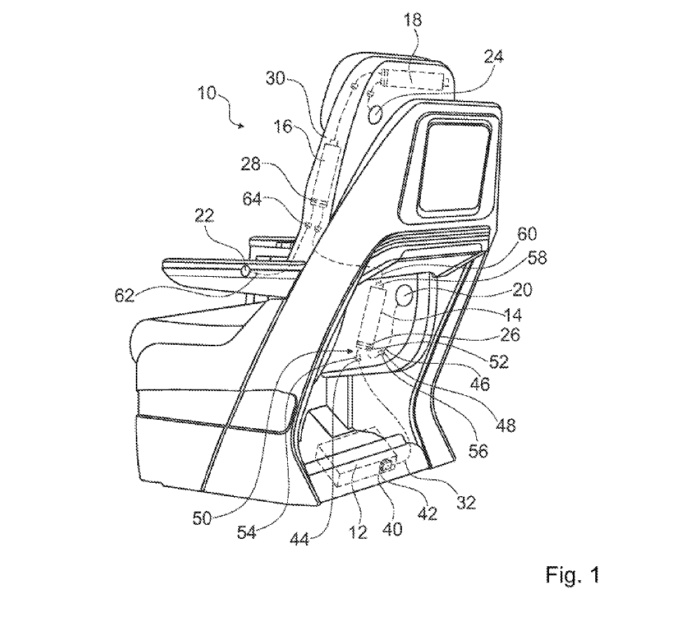

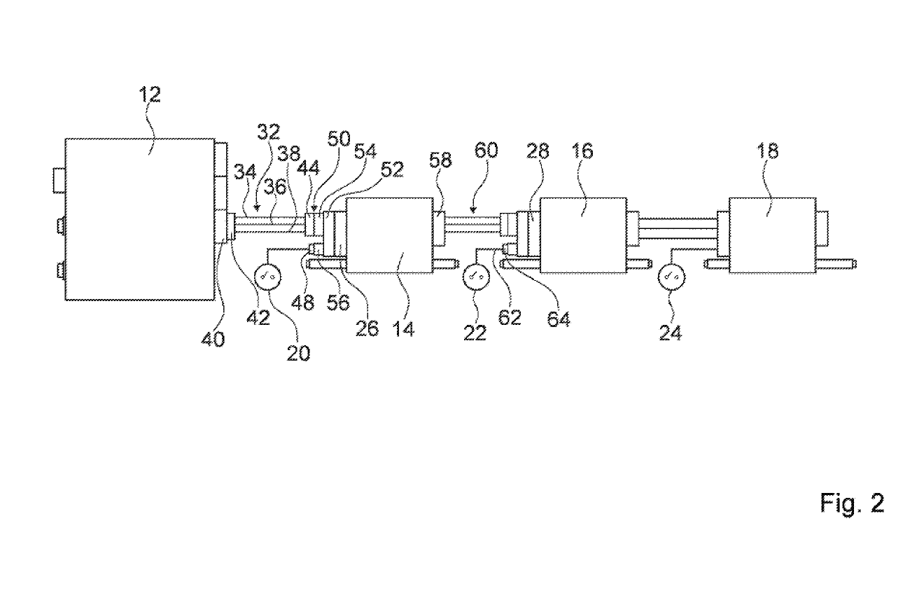

A control unit device according to the invention for an aircraft seat 10 is illustrated in FIGS. 1 and 2. FIG. 1 schematically shows an aircraft seat 10. In this case, the aircraft seat 10 illustrated in FIG. 1 is intended to be only schematic and illustrated as an example of an aircraft seat. However, in this case, it is also feasible, in principle, for the aircraft seat 10 to have a different configuration which appears to be expedient to a person skilled in the art. The aircraft seat 10 is implemented as a business or first class aircraft seat. It goes without saying that it is also feasible, in principle, for the aircraft seat 10 to be implemented as an economy class aircraft seat. The aircraft seat 10 is mounted in an aircraft which is not illustrated in any detail. To this end, the aircraft seat 10 has a stand unit, via which the aircraft seat 10 is fixedly connected to a cabin floor of the aircraft. The control unit device comprises a control and regulation unit 12. The control and regulation unit 12 is provided for controlling the electrical and/or electronic components of the aircraft seat 10. However, it is also feasible, in principle, for the control and regulation unit 12 to be provided for controlling electrical and/or electronic components of a plurality of aircraft seats 10. The aircraft, not illustrated in any detail, comprises a central control and regulation unit, not illustrated and described in any detail, to which the control and regulation unit 12 is connected. In this case, the control and regulation unit 12 of the aircraft seat 10, together with other control and regulation units of the aircraft, for example with other control and regulation units 12 of other aircraft seats 10, is coupled to the central control and regulation unit of the aircraft via a suitable data connection.

The control unit device according to the invention comprises a first actuator unit 14. The actuator unit 14 comprises an actuator which is intended to adjust a position of a backrest 30 of the aircraft seat 10. In this case, the actuator unit 14 comprises an integrated control unit and a drive unit which can be driven by means of the integrated control unit and which is embodied as an electric motor. The actuator unit 14 comprises a driver element, via which the actuator is connected to the aircraft seat 10 by means of a coupling point and via which a movement for correspondingly adjusting the aircraft seat 10 is passed on to the aircraft seat 10. It is also feasible in principle, for the actuator unit to be embodied as another actuator unit which appears to be expedient to a person skilled in the art and which is provided, in particular, for adjusting other regions and components of the aircraft seat 10. The control unit device comprises a second actuator unit 16 and a third actuator unit 18 which are intended to adjust other regions and components of the aircraft seat 10. In this case, it is also feasible, for example, for the actuator units 14, 16, 18 to be designed to adjust a screen, to adjust a footrest or to adjust another component of the aircraft seat 10. In this case, it is feasible for the corresponding actuator unit 14, 16, 18 for adjusting the corresponding component of the seat to trigger translatory and/or rotary movements. Only the first actuator unit 14 will be described in detail here, it being possible to also use a description of the first actuator unit 14 to explain the second actuator unit 16 and the third actuator unit 18.

The first actuator unit 14 is coupled to the control and regulation unit 12 of the aircraft seat 10. In this case, the actuator unit 14 and the control and regulation unit 12 are connected to one another via a data cable 32. In this case, the data cable 32 has three lines 34, 36, 38 which connect the actuator unit 14 to the control and regulation unit 12. In this case, one of the lines 36 is embodied as a communications line, via which signals for interchanging information between the control and regulation unit 12 and the actuator unit 14 are transmitted. It is also feasible, in principle, for the data cable 32 to have a different number of lines 34, 36, 38, via which the actuator unit 14 is coupled to the control and regulation unit 12. The control and regulation unit 12 has a plug element 40 which is designed in a manner corresponding to a plug element 42 of the data cable 32. The data cable 32 is connected to the control and regulation unit 12 and the lines 34, 36, 38 of the data cable 32 are electrically coupled to a corresponding electronics system of the control and regulation unit 12 via the plug element 40 of the control and regulation unit 12 and the plug element 42 of the data cable 32.

The actuator unit 14 comprises a first plug element 26. The actuator unit 14 is coupled to the control and regulation unit 12 via the plug element 26. The plug element 26 is embodied as an aviation-approved plug element. In this case, the plug element 26 is embodied as a D-sub 9-pin plug. The data cable 32, which is provided for connecting the actuator unit 14 to the control and regulation unit 12, comprises a second plug element 44 which is provided to be connected to the plug element 26 of the actuator unit 14. If the plug element 26 of the actuator unit 14 is connected to the second plug element 44 of the data cable 32, the actuator unit 14 is electrically coupled to the control and regulation unit 12 via the data cable 32. In this case, the plug element 26 of the actuator unit 14 has a plurality of pins, not illustrated in any detail, via which the actuator unit 14 is connected to the control and regulation unit 12. The pins are embodied as contact elements of the plug element 26 of the actuator unit 14, said contact elements being electrically connected to an internal electronics system of the actuator unit 14. The electronics system which is connected to the corresponding pin is electrically connected to a corresponding line 34, 36, 38 of a corresponding data cable 32, which is connected to the plug element 26 of the actuator unit 14 via its plug element 44, via the pins of the plug element 26.

The control unit device comprises a first additional unit 20. The first additional unit 20 is embodied as a sensor element. The first additional unit 20 which is embodied as a sensor element is provided for outputting a corresponding sensor signal depending on a physical condition. In this case, the additional unit 20, which is embodied as a sensor element, is implemented as a location sensor and provides a signal which is dependent on a location of the backrest 30. It is also feasible, in principle, for the additional unit 20, which is embodied as a sensor element, to be implemented as another sensor which appears to be expedient to a person skilled in the art, such as a temperature sensor, a force sensor or a distance sensor for example. The first additional unit 20 is coupled to the control and regulation unit 12 via the first actuator unit 14. The first additional unit 20 is connected directly to the first actuator unit 14. In this case, a signal which is output by the additional unit 20 which is embodied as a sensor element is initially passed on to the first actuator unit 14 and from there, via the data cable 32, to the control and regulation unit 12 where it is then processed. In this case, it is also feasible, in principle, for the signal which is provided by the additional unit 20, which is embodied as a sensor element, to be processed directly by the integrated control unit of the actuator unit 14. In this case, it is feasible for the signal which is provided by the additional unit 20 which is embodied as a sensor element to be passed on to the control and regulation unit 12 of the control unit device after processing in the integrated control unit, or else for the integrated control unit of the actuator unit 14 to directly transmit an output signal to an actuator of the actuator unit 14 or to another actuator unit 14 on the basis of the signal from the additional unit 20, which signal is processed in the integrated control unit.

The first additional unit 20 is connected to the actuator unit 14 via the plug element 26 of the actuator unit 14. The plug element 26 has two further pins, via which the additional unit 20 is connected to the actuator unit 14. The two pins are embodied as sensor inputs to the actuator unit 14. The additional unit 20, which is connected to the plug element 26, is coupled to the internal electronics system of the actuator unit 14 via the two pins. The integrated control unit of the actuator element has two inputs, via which in each case one pin of the plug element 26 of the actuator unit 14 for the additional unit 20 is connected. The signal which is provided by the additional unit 20 is passed to the integrated control unit of the actuator unit 14 via the pins, and processed there. It is also feasible, in principle, for the plug element 26 of the actuator unit 14 to have only one pin or more than two pins, via which the first additional unit 20 is connected directly to the plug element 26 of the actuator unit 14.

In order to connect the first additional unit 20, the first additional unit 20 has a cable 46 which comprises a plug element 48 at one end. The plug element 48 is intended to be coupled to the plug element 26 of the actuator unit 14 in order to connect the first additional unit 20 to the first actuator unit 14 in this way.

The control unit device comprises an intermediary plug element 50. The intermediary plug element 50 is arranged between the plug element 26 of the first actuator unit 14 and the plug element 44 of the data cable and the plug element 48 of the cable 46 of the first additional unit 20. In this case, the intermediary plug element 50 has, on a first side, a plug 52 which is designed in a manner corresponding to the plug element 26 of the actuator unit 14. The plug 52 of the first side of the intermediary plug element 50 is connected to all of the pins of the plug element of the actuator unit 14. On a second side, the intermediary plug element 50 forms two plugs 54, 56 which are separate from one another. The first plug 54 on the second side of the intermediary plug element 50 is intended to be connected to the plug element 44 of the data cable 32 which is connected to the control and regulation unit 12, and is electrically coupled to the first pin of the plug element 26 of the first actuator unit 14. The second plug 56 on the second side of the intermediary plug element 50 is intended to be connected to the plug element 48 of the cable 46 of the additional unit 20 and is electrically coupled to the two further pins which are intended for the input of the additional unit 20. The data cable 32 for connection to the control and regulation unit 12 and the cable 46 of the first additional unit 20 can be coupled to the plug element 26 of the actuator unit 14 in a simple manner via the intermediary plug element 50. It is also feasible, in principle, for the control unit device to not have an intermediary plug element 50 and for the plug element 44 of the data cable 32 to be intended to be connected to the control and regulation unit 12 and also for the plug element 48 of the cable 46 of the additional unit 20 to be designed such that they can both be fitted directly to the plug element 26 of the actuator unit 14 at the same time.

The control unit device comprises a second additional unit 22. In this case, the second additional unit 22 is embodied as an actuator element. The second additional unit 22 which is embodied as an actuator element changes its state on the basis of driving by the control and regulation unit 12. The actuating element is implemented as an LED signal element. In this case, the second additional unit 22 is coupled to the control and regulation unit 12 via the second actuator unit 16. The second actuator unit 16 is connected physically in series with the first actuator unit 14. In this case, it is likewise feasible for the actuator units 14, 16 to be connected physically in parallel or in star. To this end, the first actuator unit 14 has a second plug element 58. A data cable 60 is connected to the second plug element 58 of the first actuator unit 14, the second actuator unit 16 being connected to the second actuator unit 16 via a first plug element 28 of the second actuator unit 16 via said data cable. The second actuator unit 16 is therefore coupled to the control and regulation unit 12 via the first actuator unit 14. In this case, the second additional unit 22 is connected to the second actuator unit 16, in an equivalent manner to the connection of the first additional unit 20 to the first actuator unit 14. The second additional unit 22 likewise has a cable 62 with a plug element 64, via which the second additional unit is coupled to the first plug element 28 of the second actuator unit 16. In this case, the first plug element 28 of the second actuator unit 16 has two pins, via which the second additional unit 22 is connected to the second actuator unit 16. The two pins via which the second additional unit 22 is connected to the second actuator unit 16 and furthermore to the control and regulation unit 12 are embodied as switching outputs. The second additional unit 22 which is embodied as an actuator element is driven via the switching pins which are embodied as switching outputs.

The control unit device comprises a third additional unit 24 which is connected to the control and regulation unit 12 via the third actuator unit 18. The third additional unit 24 is likewise embodied as an actuator element which is not intended to be described in any detail here. However, it is also feasible, in principle, for the third additional unit 24 to be embodied as a sensor element. Furthermore, it is feasible for the control unit device to have further actuator units, via which in each case one further additional unit of the control unit device is connected to the control and regulation unit 12. It is feasible, in principle, for the inputs or outputs to be connected to the integrated control unit of the actuator units 14, 16, 18 via the additional units 20, 22, 24 and to be processed in a digital or analog manner by the integrated control unit.

### REFERENCE NUMERALS

10 Aircraft seat
12 Control and/or regulation unit
14 Actuator unit
16 Actuator unit
18 Actuator unit
20 Additional unit
22 Additional unit
24 Additional unit
26 Plug element
28 Plug element
30 Backrest
32 Data cable
34 Line
36 Line
38 Line
40 Plug element
42 Plug element
44 Plug element
46 Cable
48 Plug element
50 Intermediary plug element
52 Plug
54 Plug
56 Plug
58 Plug element
60 Data cable
62 Cable
64 Plug element

1. A control unit device for an aircraft seat, having a control and/or regulation unit, having at least one actuator unit which is coupled to the control and/or regulation unit, and having at least one additional unit, wherein the additional unit is coupled to the control and/or regulation unit via the actuator unit.

2. The control unit device as claimed in claim 1, wherein the actuator unit comprises at least one plug element, via which the actuator unit is coupled to the control and/or regulation unit, wherein the additional unit is connected to the actuator unit via the plug element.

3. The control unit device as claimed in claim 1, wherein the plug element has at least one pin via which the actuator unit is connected to the control and/or regulation unit, and has at least one further pin, via which the additional unit is connected to the actuator unit.

4. The control unit device as claimed in claim 1, wherein the actuator unit has an integrated control unit which has at least one input, via which the pin for the additional unit is connected.

5. The control unit device as claimed in claim 1, wherein the additional unit is embodied as a sensor element.

6. The control unit device as claimed in claim 1, wherein the additional unit is embodied as an actuator element.

7. The control unit device as claimed in claim 1, wherein the plug element is embodied as an aviation-approved plug element.

8. The control unit device as claimed in claim 1, wherein the plug element is embodied as a D-sub 9-pin plug.

9. A method for connecting an actuator unit and an additional unit to a control and/or regulation unit, wherein the additional unit is connected to the control and/or regulation unit via the actuator unit.

10. An aircraft seat having a control unit device as claimed in claim 1.

11. The control unit device as claimed in claim 2, wherein the plug element has at least one pin via which the actuator unit is connected to the control and/or regulation unit, and has at least one further pin, via which the additional unit is connected to the actuator unit.

12. The control unit device as claimed in claim 2, wherein the actuator unit has an integrated control unit which has at least one input, via which the pin for the additional unit is connected.

13. The control unit device as claimed in claim 2, wherein the additional unit is embodied as a sensor element.

14. The control unit device as claimed in claim 2, wherein the additional unit is embodied as an actuator element.

15. The control unit device as claimed in claim 2, wherein the plug element is embodied as an aviation-approved plug element.

16. The control unit device as claimed in claim 2, wherein the plug element is embodied as a D-sub 9-pin plug.

17. An aircraft seat having a control unit device as claimed in claim 2.

18. The control unit device as claimed in claim 3, wherein the actuator unit has an integrated control unit which has at least one input, via which the pin for the additional unit is connected.

19. The control unit device as claimed in claim 3, wherein the additional unit is embodied as a sensor element.

20. The control unit device as claimed in claim 3, wherein the additional unit is embodied as an actuator element.
